(19) United States
(12) Patent Application Publication
(10) Pub. No.: US 2020/0249330 A1
(43) Pub. Date: Aug. 6, 2020

(54) METHOD AND APPARATUS FOR DETERMINING THE ACCURACY OF A DISTANCE MEASURING DEVICE

(71) Applicant: FARO Technologies, Inc., Lake Mary, FL (US)

(72) Inventors: Robert E. Bridges, Kennett Square, PA (US); John M. Mountney, Philadelphia, PA (US)

(21) Appl. No.: 16/674,743

(22) Filed: Nov. 5, 2019

Related U.S. Application Data
(60) Provisional application No. 62/799,996, filed on Feb. 1, 2019.

(51) Int. Cl. G01S 7/497

(52) U.S. Cl. CPC G01S 7/497

(57) ABSTRACT

An apparatus and method for calibrating a distance meter using a double-pass configuration based on reflection off an intermediate retroreflector. The system includes a first distance meter operable to send a first beam light in a first path that intercepts a first retroreflector and a second retroreflector, to receive the first beam of light after reflection from the first retroreflector and the second retroreflector, and to measure a first distance traveled by the first beam of light, the first retroreflector being located at a first position. The system further includes a second distance meter operable to send a second beam of light in a second path that intercepts the first retroreflector, to receive the second beam of light after reflection from the first retroreflector, and to measure a second distance traveled by the second beam of light.

### CROSS REFERENCE TO RELATED APPLICATIONS

This application claims the benefit of U.S. Provisional Application Ser. No. 62/799,996, filed Feb. 1, 2019, the entire disclosure of which is incorporated herein by reference.

### BACKGROUND

The present disclosure relates to evaluation of a distance measuring device. Such a distance measuring device might be an interferometer (IFM) or an absolute distance meter (ADM). Such a distance measuring device may be a stand-alone distance meter, or it may be incorporated into another device such as a laser tracker, total station, or time-of-flight (TOF) scanner.

A laser tracker is a particular type of coordinate-measuring device that tracks the retroreflector target with one or more beams it emits, which may include light from a laser or non-laser light source. Coordinate-measuring devices closely related to the laser tracker are the TOF scanner and the total station. The TOF scanner steps one or more beams of light to points on a surface. It picks up light reflected from the surface and in response determines a distance and two angles to each surface point. A total station is a 3D measuring device most often used in surveying applications. It may be used to measure the coordinates of a diffusely scattering target or a retroreflective target. Hereinafter, the term laser tracker is used in a broad sense to include laser scanners and total stations and to include dimensional measuring devices that emit laser or non-laser light.

In many cases, a laser tracker sends a beam of light to a retroreflector target. A common type of retroreflector target is the spherically mounted retroreflector (SMR), which comprises a cube-corner retroreflector embedded within a metal sphere. The cube-corner retroreflector comprises three mutually perpendicular mirrors. The vertex, which is the common point of intersection of the three mirrors, is located at the center of the sphere. Because of this placement of the cube corner within the sphere, the perpendicular distance from the vertex to any surface of the SMR rests remains constant, even as the SMR is rotated. Consequently, the laser tracker can measure the 3D coordinates of a surface-under-test by following the position of an SMR as it is moved over the surface-under-test. Stating this another way, the laser tracker needs to measure only three degrees of freedom (one radial distance and two angles) to fully characterize the 3D coordinates of a surface.

One type of laser tracker contains only an interferometer (IFM) without an absolute distance meter (ADM). If an object blocks the path of the laser beam from one of these trackers, the IFM loses its distance reference. The operator must then track the retroreflector to a known location to reset to a reference distance before continuing the measurement. A way around this limitation is to put an ADM in the tracker. The ADM can measure distance in a point-and-shoot manner. Some laser trackers contain only an ADM without an interferometer.

A gimbal mechanism within the laser tracker may be used to direct a laser beam from the tracker to the SMR. Part of the light retroreflected by the SMR enters the laser tracker and passes onto a position detector. A control system within the laser tracker uses position of the light on the position detector to adjust the rotation angles of the mechanical axes of the laser tracker to keep the beam of light centered on the SMR. In this way, the tracker is able to follow (track) a moving SMR.

Angle measuring devices such as angular encoders are attached to the mechanical axes of the tracker. The one distance measurement and two angle measurements of the laser tracker are sufficient to completely specify a three-dimensional location of the SMR.

Today laser trackers measure to relatively long distances. For laser trackers used with SMRs, a typical maximum measurement range is 80 meters. For TOF scanners or total stations that directly measure surfaces with a beam of light, ranges may extend to several hundred meters or further.

It is often necessary to determine the accuracy of laser trackers to within a few micrometers over its entire measurement range. It is often the case that laboratory space is not available to evaluate the performance of a distance meter within a laser tracker over the tracker's full measurement range. A way is needed to enable relatively accurate evaluation of distance meters over the full measurement range of the distance meters, even when that much laboratory space is not available. Furthermore, it is desirable that such measurements be made relatively quickly and in a fully automated manner. A further objective is to make the evaluation of the distance meters relatively insensitive to environmental influences such as variations in ambient air temperature over the test region.

Although methods for measuring the performance of distance meters are generally suitable for their intended purpose, some limitations still exist in measurement methods with respect to required laboratory space, speed and automation of measurements, and sensitivity to environmental conditions. What is needed is an improved method for evaluating the performance of distance meters. Such distance meters may be stand-alone distance meters or may be incorporated in other instruments such as laser trackers.

### SUMMARY

According to an embodiment of the present invention, a system includes: a first distance meter operable to send a first beam light in a first path that intercepts a first retroreflector and a second retroreflector, to receive the first beam of light after reflection from the first retroreflector and the second retroreflector, and to measure a first distance traveled by the first beam of light, the first retroreflector being located at a first position; and a second distance meter operable to send a second beam of light in a second path that intercepts the first retroreflector, to receive the second beam of light after reflection from the first retroreflector, and to measure a second distance traveled by the second beam of light.

According to another embodiment of the present invention, a method includes: sending a first beam of light from a first distance meter in a first path that intercepts a first retroreflector and a second retroreflector, the first retroreflector being located at a first position; receiving with the first distance meter the first beam of light after reflection from the first retroreflector and the second retroreflector; measuring with the first distance meter a first distance traveled by the first beam of light; sending with a second distance meter a second beam of light in a second path that intercepts the first retroreflector; receiving with the second distance meter the second beam of light after reflection from the first retroreflector; measuring with the second distance meter the second distance traveled by the second beam of light; and storing the measured first distance and the measured second distance.

### BRIEF DESCRIPTION OF THE DRAWINGS

Referring now to the drawings, exemplary embodiments are shown which should not be construed to be limiting regarding the entire scope of the disclosure, and wherein the elements are numbered alike in several FIGURES:

FIG. 1A is a schematic, isometric view of a laser tracker measuring distances to a retroreflector moved to a number of distances from the tracker;

FIG. 1B is a schematic, isometric view of a laser tracker measuring distances to an SMR, with the SMR sometimes receiving light reflected off a mirror;

FIG. 2 is an isometric view of a laser tracker and a reference interferometer each sending a beam of light to a retroreflector located on a motorized rail in accordance with an embodiment;

FIG. 3 is a top view of a laser tracker and a reference interferometer each sending a beam of light to a retroreflector located on a motorized rail according to an embodiment;

FIG. 4 is a side view of a laser tracker and a reference interferometer each sending a beam of light to a retroreflector located on a motorized rail according to an embodiment;

FIG. 5 is a close-up isometric view of a laser tracker, a reference interferometer, and opto-mechanical components according to an embodiment;

FIG. 6 is a close-up isometric view of a retroreflector coupled to mechanical rail components according to an embodiment;

FIG. 7 is an isometric view of a relatively long section of rail used to evaluate the performance of a distance meter within a laser tracker according to an embodiment;

FIG. 8 is a schematic representation of a method for further reducing the size of a rail for evaluating a distance meter according to an embodiment; and

FIG. 9 is a block diagram of electrical circuitry and processors within the system according to an embodiment.

The detailed description explains embodiments of the invention, together with advantages and features, by way of example with reference to the drawings.

### DETAILED DESCRIPTION

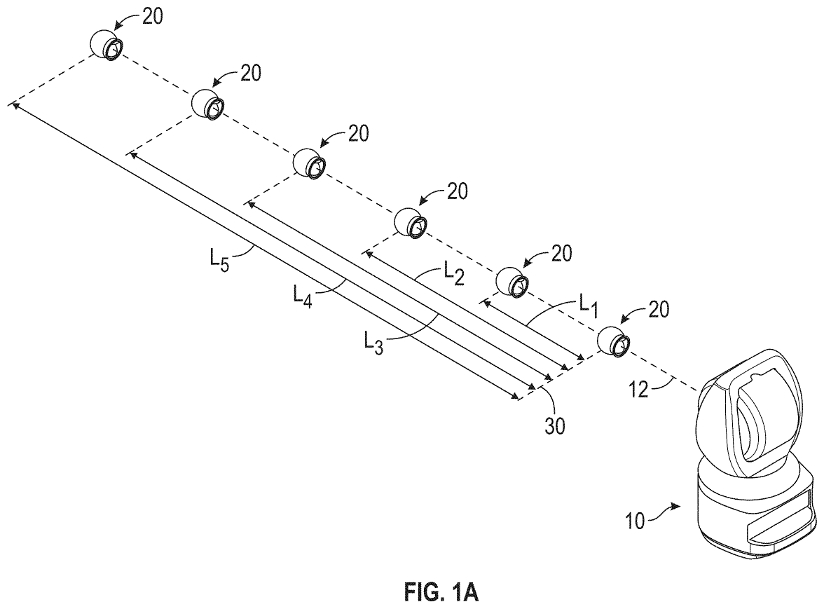

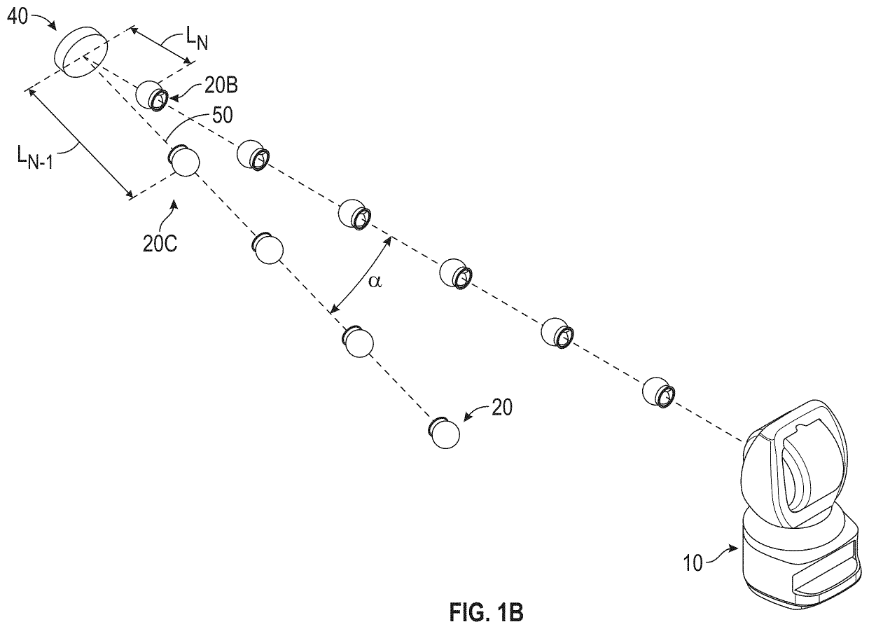

In FIG. 1A, a laser tracker 10 sends light 12 to an SMR 20 or other retroreflector in a number of different positions. The tracker 10 measures the distance to the SMR 20 at each position to obtain distances L₁, L₂, L₃, L₄, L₅ with respect to a starting position 30. If the actual distances L₁, L₂, L₃, L₄, L₅ are known to a relatively high accuracy, the error of the tracker 10 in measuring these distances can be determined. It should be appreciated that FIG. 1A shows the SMR 20 located at different positions, not multiple SMR's being measured simultaneously since the light emitted by the tracker 10 does not pass through the SMR.

FIG. 1B shows a mirror 40 placed a distance L_{N} after an SMR 20B, which indicates an SMR 20 located at a position B. The light 50 reflected off the mirror 40 travels to the SMR 20C, which is located a distance L_{N+1} after the mirror. It should be appreciated that the SMR 20C may be the SMR 20B moved to the illustrated location. The arrangement of FIG. 1B, in which light is reflected off the mirror 40 at an angle α, is sometimes used to compensate or evaluate laser trackers (for example, by using a so-called two-face test), but it is of limited value in assessing the accuracy of the distance measuring device in the tracker 10. A first difficulty is in accurately determining the distances L_{N} and L_{N+1}. The spherical surface of the SMR 20B can be placed against the surface of the mirror 40 to measure L_{N}, but that requires that the sphere be contacted to the mirror in the exactly the same place each time. Further, the measured distance L_{N} must be corrected to account for the depth error of the SMR vertex relative to the sphere center. A second, greater difficulty is that a reference interferometer cannot be used to measure the distance L_{N+1} in the setup of FIG. 1B since that would typically breaking the beam (e.g. the SMR does not continuously reflect light back to the tracker) before measuring the distance L_{N+1}, resulting in a lost beam count in the reference interferometer. Although it would be possible to use a distance measuring device other than an interferometer to measure the all the distances, including L_{N} and L_{N+1}, in most cases an interferometer provides the desired accuracy to sensitively determine the performance of the distance meter in a laser tracker.

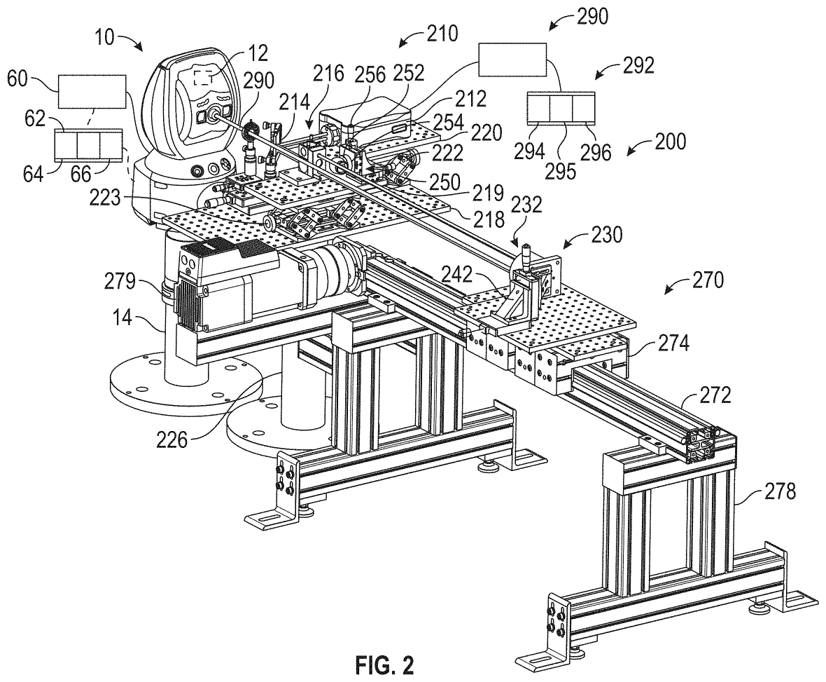

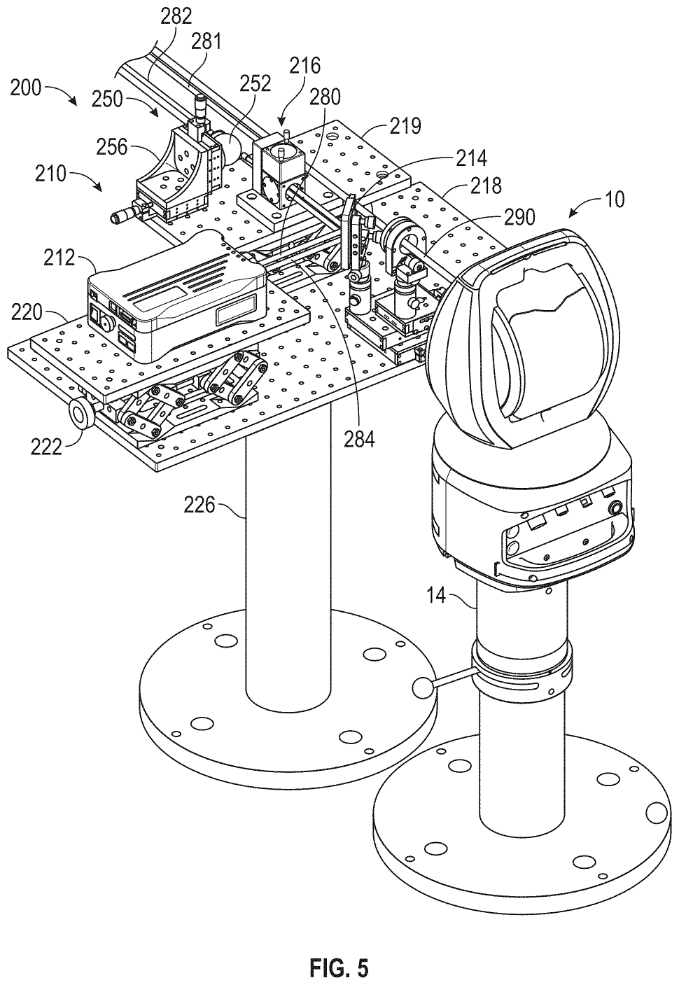

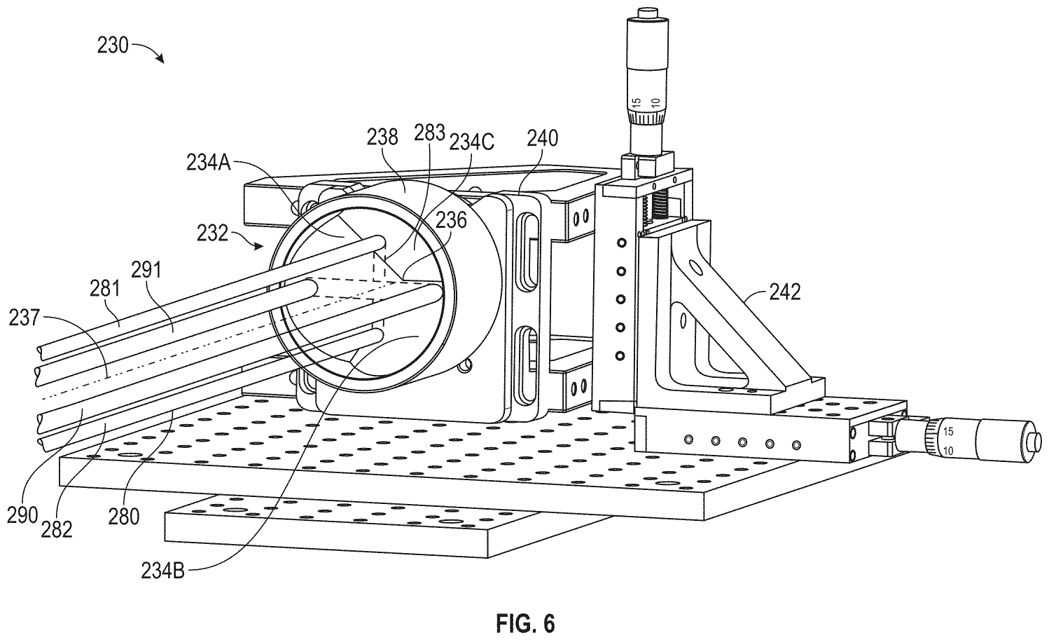

FIGS. 2, 3, 4 are isometric, top, and side views of a portion of a system 200 for determining the accuracy of a distance measuring device, also known as a distance meter. FIGS. 5 and 6 are a close up views of system elements. In the example illustrated by these figures, the distance meter 12 is located within the laser tracker 10. In an embodiment, the system 200 includes the tracker-under-test 10, a reference distance meter 210, a first retroreflector assembly 230, a second retroreflector assembly 250, and a motorized rail assembly 270. In an embodiment, the reference distance meter 210 is a reference interferometer 210. The tracker assembly includes the tracker 10 and tracker stand 14. In an embodiment, the reference interferometer assembly 210 includes a laser source 212, a fold mirror 214, a long-range linear optics assembly 216, mounting plates 218, 219, 220, height jacks 222, 223, and mounting stand 226.

In an embodiment, the first retroreflector assembly 230 includes a retroreflector 232, a retroreflector housing 238, a mounting plate 240, and an adjustment stage 242. In an embodiment, the retroreflector 232 is a cube-corner retroreflector. In other embodiments, the retroreflector is a different type of retroreflector such as a cat's eye retroreflector. In an embodiment, a cube-corner retroreflector 232 includes three mutually perpendicular reflectors 234A, 234B, 234C that intersect in a vertex 236. In an embodiment, the cube-corner retroreflector 232 is made of glass. In another embodiment, the cube-corner retroreflector is made of three separate reflective surfaces, each surrounded on the reflective side by air. In an embodiment, the second retroreflector assembly 250 includes an SMR 252, a nest 254, and an adjustment stage 256.

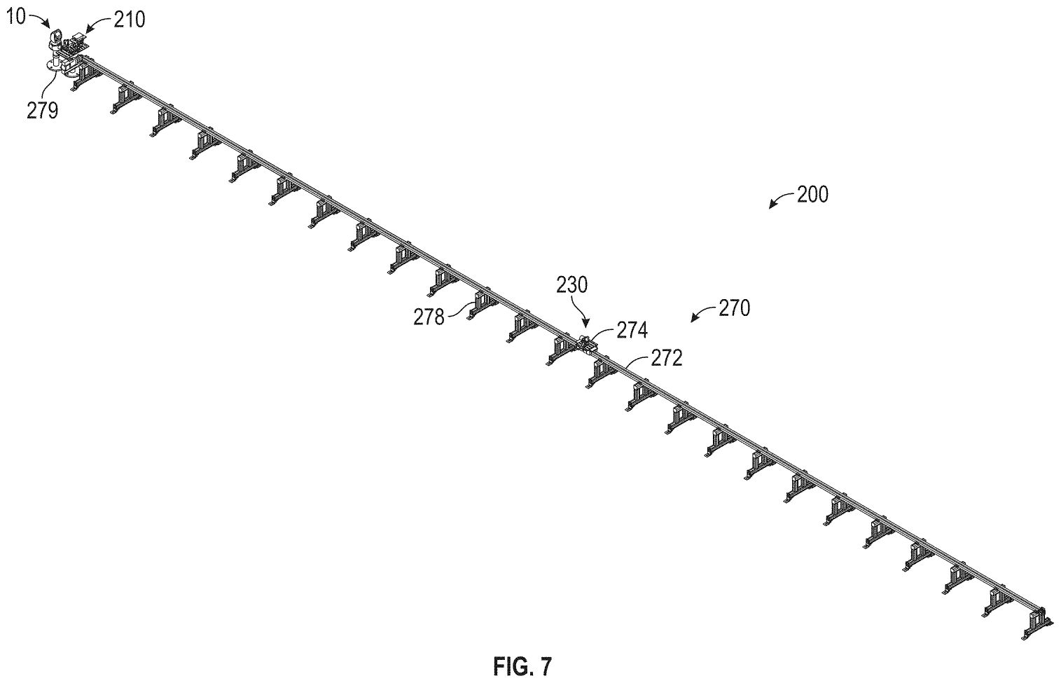

In an embodiment, the motorized rail assembly 270 includes a central rail 272, a carriage 274, a collection of stands 278, and a motor 279. The carriage 274 rides on the central rail 272 and supports the first retroreflector assembly 230. In an embodiment, the motor 279 drives a belt that moves the carriage 274 along the central rail 272. In an embodiment, the central rail is extended to cover tens of meters, as illustrated in FIG. 7.

In an embodiment, the laser source 212 emits a beam of light 280 and receives a returning beam of light 284. In an embodiment, the light is produced by a frequency stabilized helium-neon (HeNe) laser that emits red light. Many types of reference interferometer assemblies may be used, and many different principles of operation may be used by these reference interferometer assemblies. In an embodiment, the light 280 emitted by the laser source 212 reflects off the mirror 214 and passes through the linear-optics assembly 216. The beam of light 281 emerges from the linear optics assembly 216 and travels to the cube-corner retroreflector 232 where it intersects the retroreflector as shown in FIG. 6. In general, the beam of light 281 reaches one of the reflective panels 234A, 234B, or 234C and reflects off each of the other two reflective panels before emerging as the return beam 282. It is a principle applicable to cube corner retroreflectors that a reflected beam 282 is parallel to and travels in a direction opposite that of the incident beam 281. Each cube corner retroreflector 232 has an axis of symmetry 237 that passes through the vertex 236, as shown in FIG. 6. A further principle applicable to a cube-corner retroreflector is that an incident beam 281 is reflected to the opposite side of the vertex 236 with the perpendicular distance from the incident beam 2801 to the axis of symmetry 237 equal to the perpendicular distance from the outgoing beam 282 to the axis of symmetry 237. This displacement in position from the incoming beam 281 to the outgoing beam 282 is represented by the dashed path 283. The reflected beam 282 returns to the linear-optics assembly 216 and passes back into the laser source 212 as the beam of light 284.

In an embodiment, the laser source 212 includes optical and electrical components that together determine the distance between the linear-optics assembly 216 and the cube-corner retroreflector 232. In an embodiment, a processor 290 is coupled to the laser source 212. The processor may be internal to the laser source or coupled to the laser source 212 by wired or wireless connections. In an embodiment, the processor 290 includes memory and is part of a computer. In an embodiment, the distance between the linear-optics assembly 216 and the retroreflector 232 depends on the wavelength of the laser light emitted by the laser source 212, which in turn depends on the temperature, pressure, and relative humidity of the air through which the laser beam travels. In an embodiment, the processor 290 is further coupled to a weather station 292 that includes a temperature sensor 294, a pressure sensor 295, and a humidity sensor 296.

In an embodiment, signals from the weather station 292 are sent to the processor 290 through wired or wireless connections. In an embodiment, the effect of temperature, pressure, and humidity on the index of refraction of the air is determined using a modified Edlin equation. In other embodiments, another equations such as the Ciddor equation is used. The length traveled in a given interval is determined by dividing the speed of light in vacuum (299,792,458 meters per second) by the index of refraction of the air based on readings provided by the weather station 292.

In an embodiment, the distance moved by the retroreflector 232 is measured by the reference interferometer assembly 210 and compared to an equivalent distance moved by the retroreflector 232 as determined by a distance meter 12 under test. In an embodiment, the distance meter 12 is included in a laser tracker 10. The reference interferometer assembly 210 and weather station 292 components are selected for accuracy and are calibrated by accredited calibration laboratories to obtain a relatively low expanded uncertainty in the determined distance traveled by the retroreflector 232. In an embodiment, the tracker 10 is connected to a processor 60, which receives information from a temperature sensor 62, pressure sensor 64, and humidity sensor 66. The processor 60 may be internal to the tracker, external to the tracker, or a combination of internal or external processors. In some embodiments, the processor 60 represents one or more processors that may include any sort of electrical processing device such as field programmable gate arrays, digital signal processing devices, microprocessors, memory, and any other sort of computing or signal processing device.

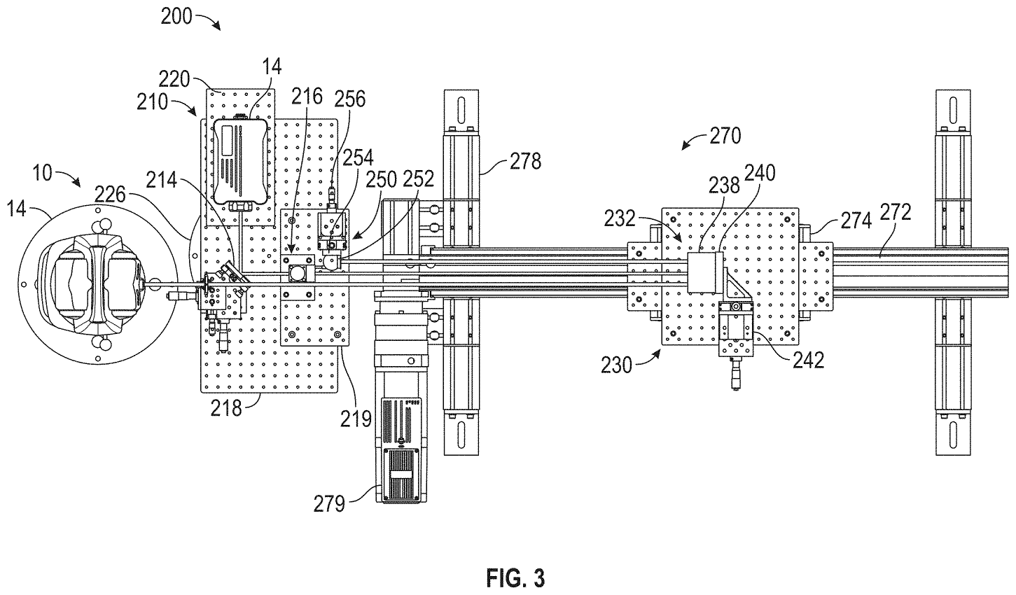

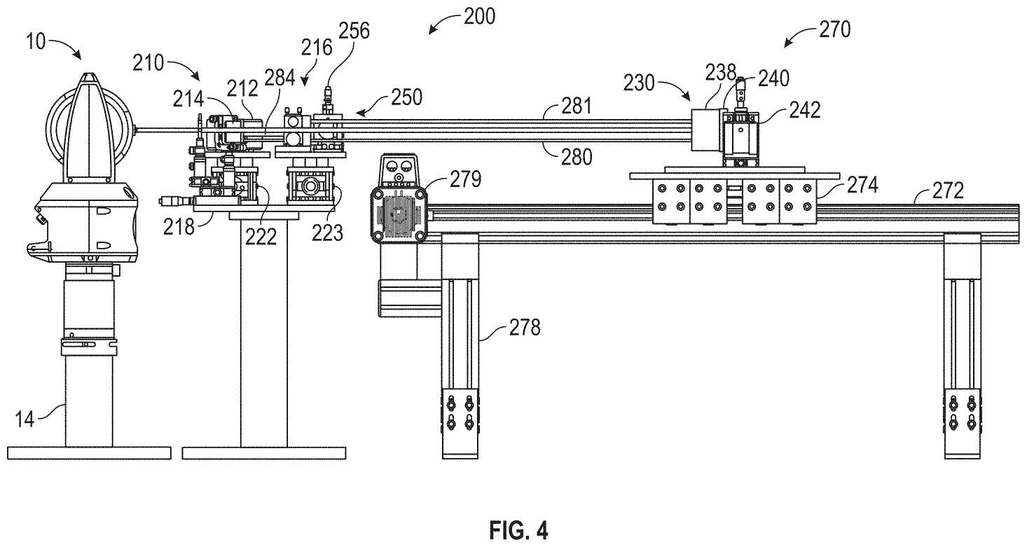

In an embodiment, the tracker 10 emits a beam of light 290, which arrives at the retroreflector and is reflected as the beam 291 at a position on the opposite side of the axis of symmetry 237 of the cube-corner retroreflector 232. As clearly shown in FIGS. 3 and 4, the SMR 252 is positioned to intercept the beam 291 at the vertex of the retroreflector 252, which causes the beam 291 to be reflected back on itself. The beam 291 retraces its path back to the retroreflector 232, where it is reflected to be coincident with the beam 290. The beam 290 enters the tracker 10, where the distance meter 12 determines the total distance traveled. Beginning with the retroreflector starting at an arbitrary initial position on the central rail 272 and moving the retroreflector to an arbitrary final position on the central rail 272, the change in distance traveled by the beam from the tracker 10 is exactly twice the change in distance traveled by the beam from the reference interferometer 210. In an embodiment, the change in distance measured by the tracker is compared to twice the change in distance measured by the reference interferometer. The difference between these two values is taken to be the error in the tracker measurement. This error, which is mainly attributable to the distance meter 12 in the tracker 10, may be compared to the tracker specifications. In most cases, tracker specifications are given as maximum permissible error (MPE) values. Any error in a measured value of the tracker distance meter 12, as compared to a corresponding measured by the reference interferometer, is compared to the MPE value of the tracker distance meter 12 to determine whether the distance meter 12 is in conformance with its specifications. In an embodiment, a calibration report provides measured errors and corresponding MPE values for each distance meter 12.

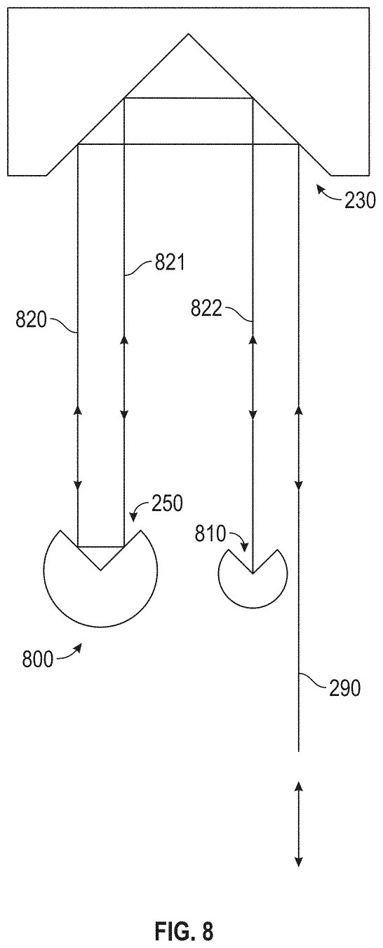

One advantage of the method described above in reference to FIGS. 2, 3, 4, 5, 6, 7 is that approximately half the factory space is required to check the performance of a tracker having a relatively large range. For example, many laser trackers today have specified length measurement accuracies given to 80 meters. International standards usually require that measurements be carried out to at least 66 percent of their maximum values, which in this case would be about 53 meters. By using the arrangement described in reference to FIGS. 2, 3, 4, 5, 6, the required length of the rail can be cut in half to approximately 26.5 meters. Further reductions in required space are also possible, as described below in reference to FIG. 8.

Another advantage of the system shown in FIGS. 2, 3, 4, 5, 6, 7 is that the beams of light from the reference interferometer 210 and the distance meter under test 12 is that the two beams travel over nearly the path length in parallel and in close proximity. As a result, the average temperature of the air through which light travels from the reference interferometer 210 and the distance meter under test 12 travel are nearly the same, thereby contributing a very small uncertainty to the comparison of the two distance meters 210 and 12. Yet another advantage of the system 200 is that it may be totally automated, thereby saving operator time.

A system 800 that enables a reduction in factory space by a factor of four is shown in FIG. 8. In an embodiment, a reference interferometer is set up in a configuration similar to that illustrated in FIGS. 2, 3, 4, 5, 6, 7 but a third retroreflector assembly 810 is added to the first retroreflector assembly. As in the FIGS. 2, 3, 4, 5, 6, 7, the system 800 includes a first retroreflector assembly 230, a second retroreflector assembly 230 and a beam 290 launched from and returned to the laser tracker 10. In an embodiment, the beam 290 emerges from the first retroreflector assembly 230 as the beam 820. The beam 820 does not strike the second retroreflector 250 at the vertex of the retroreflector but offset a distance from the vertex somewhat so that the reflected beam 821 returns to the retroreflector assembly 230 before emerging as the beam 822, which strikes the retroreflector 810 at its vertex. The beams 822, 821, 820, and 290 retrace their paths to the tracker 10. The change in path distance traveled by the beams from the tracker 10 travel four times as far as the beam from the reference interferometer 210. With this method, a rail of only slightly longer than 20 meters is able to measure the full range of a tracker 10 having a range of 80 meters. In an embodiment, additional retroreflectors are added to the system, further reducing the testing space.

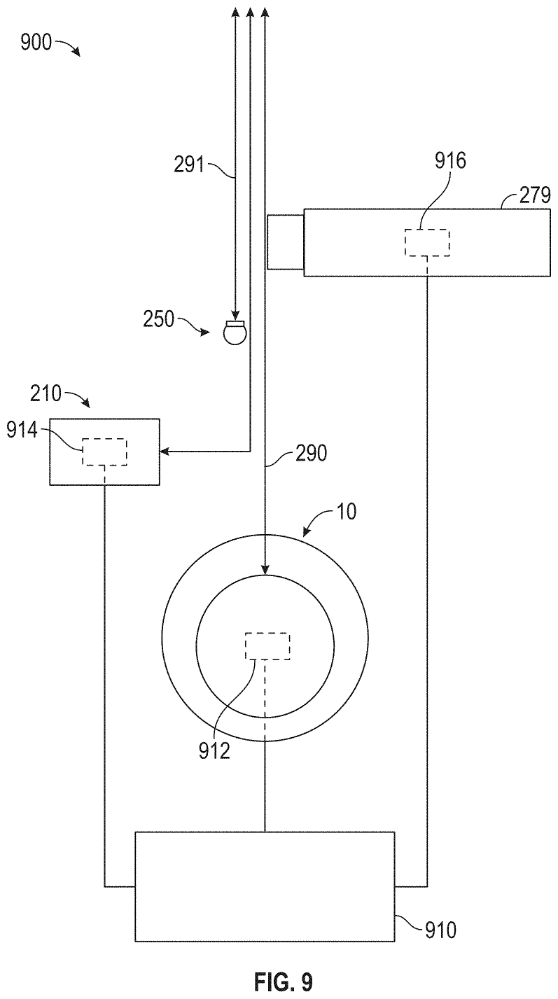

FIG. 9 illustrates an embodiment in which a system 900 includes a computer 910 that is in communication with processors 912, 914, 916 in the tracker 10, the reference interferometer assembly 210 and the motor 279, respectively. Communication among computing and processing elements may be wired or wireless means.

Terms such as processor, controller, computer, DSP, FPGA are understood in this document to mean a computing device that may be located within an instrument, distributed in multiple elements throughout an instrument, or placed external to an instrument.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A system comprising:
a first distance meter operable to send a first beam light in a first path that intercepts a first retroreflector and a second retroreflector, to receive the first beam of light after reflection from the first retroreflector and the second retroreflector, and to measure a first distance traveled by the first beam of light, the first retroreflector being located at a first position; and
a second distance meter operable to send a second beam of light in a second path that intercepts the first retroreflector, to receive the second beam of light after reflection from the first retroreflector, and to measure a second distance traveled by the second beam of light.

2. The system of claim 1 wherein:
the first distance meter is further operable to send a third beam of light in a third path that intercepts the first retroreflector and the second retroreflector, to receive the third beam of light after reflection from the first retroreflector and the second retroreflector, and to measure a third distance traveled by the third beam of light, the first retroreflector being located at a second position; and
the second distance meter is further operable to send a fourth beam of light in a fourth path that intercepts the first retroreflector, to receive the fourth beam of light after reflection from the first retroreflector, and to measure a fourth distance traveled by the fourth beam of light.

3. The system of claim 2 further comprising a processor operable to execute computer instructions that, when executed on the processor, determine an accuracy of the first distance meter based at least in part on the measured first distance, the measured second distance, the measured third distance, and the measured fourth distance.

4. The system of claim 3 further comprising a rail having a movable carriage on which the first retroreflector is mounted.

5. The system of claim 4 further comprising a motor operable to move the carriage.

6. The system of claim 1 wherein the first retroreflector is a cube-corner retroreflector.

7. The system of claim 6 wherein the first retroreflector includes a glass prism having three reflecting sides that are mutually perpendicular.

8. The system of claim 1 wherein the second distance meter is a calibrated interferometer.

9. A method comprising:
sending a first beam of light from a first distance meter in a first path that intercepts a first retroreflector and a second retroreflector, the first retroreflector being located at a first position;
receiving with the first distance meter the first beam of light after reflection from the first retroreflector and the second retroreflector;
measuring with the first distance meter a first distance traveled by the first beam of light;
sending with a second distance meter a second beam of light in a second path that intercepts the first retroreflector;
receiving with the second distance meter the second beam of light after reflection from the first retroreflector;
measuring with the second distance meter the second distance traveled by the second beam of light; and
storing the measured first distance and the measured second distance.

10. The method of claim 9 further comprising:
sending with the first distance meter a third beam of light in a third path that intercepts the first retroreflector and the second retroreflector, the first retroreflector being located at a second position;
receiving with the first distance meter the third beam of light after reflection from the first retroreflector and the second retroreflector;
measuring with the first distance meter a third distance traveled by the third beam of light;
sending with the second distance meter a fourth beam of light in a fourth path that intercepts the first retroreflector;
receiving with the second distance meter the fourth beam of light after reflection from the first retroreflector;
measuring with the second distance meter a fourth distance traveled by the fourth beam of light; and
storing the measured third distance and the measured fourth distance.

11. The method of claim 10 further comprising:
determining an accuracy of the first distance meter based at least in part on the measured first distance, the measured second distance, the measured third distance, and the measured fourth distance; and
storing the determined accuracy.

12. The method of claim 11 further comprising moving the first retroreflector on a movable carriage mounted on a rail.

13. The method of claim 12 further comprising moving the movable carriage with a motor.

14. The method of claim 9 wherein the first retroreflector is a cube-corner retroreflector.

15. The method of claim 14 wherein the first retroreflector is made of glass.
